(19) United States
(12) Patent Application Publication
(10) Pub. No.: US 2013/0055968 A1
(43) Pub. Date: Mar. 7, 2013

(54) Veterinary restraint collar and improvement

(71) Applicant: Judith G. Lippincott, Sacramento, CA (US)

(72) Inventor: Judith G. Lippincott, Sacramento, CA (US)

(21) Appl. No.: 13/199,639

(22) Filed: Sep. 6, 2011

(51) Int. Cl. A01K 13/00; A01K 15/04

(52) U.S. Cl. 119/821; 119/850

(57) ABSTRACT

A veterinary restraint collar, such as for a cat or dog, comprising one or more concentric rings of soft, flexible and non-resilient material sewn together on their inner and outer margins with binding and a drawstring passage for an elasticized drawstring on the inner margin to secure the collar around the animal's neck. Numerous sizes provide a flexible barrier restricting the animal's ability to reach treatment areas of its body with its mouth. Different materials are used for different sizes to establish the effectiveness of the collar and to provide a comfortable experience for the animal. The improvement of replacing one panel of the collar with a post-treatment instructions panel, sewn into the collar, provides veterinary and other animal professionals the means to assure the well-being of the animal through these written instructions.

### BACKGROUND OF THE INVENTION

This Application is the result of improvement to U.S. Pat. No. 5,133,295, titled Veterinary Restraint Collar. That Application, 770, 623, was filed on Oct. 3, 1991 and the '295 Patent issued on Jul. 28, 1992. The Collar is being sold in all fifty states of the United States and, also, Canada, Europe and Asia.

This invention is for a veterinary restraint collar to prevent an animal, mostly cats and dogs, experiencing injury, surgery, dental or grooming procedures, from reaching the treatment site with their mouth or from interfering with the treatment procedures. Licking, biting or chewing can defeat the effectiveness of the treatment and cause scar tissue at the treatment site or prevent treatment from being accomplished.

In 1991-92, an international search was conducted for prior art that would preclude the allowance of the '295 Patent. None was found. Following is the improvement to the '295 Patent and the applicable restraint devices issued/filed since October, 1991. With testing and use, it became obvious that improvement was needed:
Veterinary Recovery Collar to describe use
Stays to provide a stronger barrier to the animal
Binding around the neck opening and perimeter
Size labels to assure the correct size is applied
Different materials for different sizes
Private labels for each company
Pliable drawstring receptacle in one layer collars
A panel on the collar for post-treatment instructions

Schmid et al, Veterinary recovery collar, U.S. Pat. No. 6,044,802, Apr. 4, 2000 is a round pillow with a central aperture and a shawl that extends into the central aperture having a drawstring to secure it on the animal. The animal's mouth is prevented from bodily contact, but the bulk around it's neck makes lying down or eating difficult, if not impossible. Bowen, Adjustable pet collar, U.S. Pat. No. 6,244,222, Jun. 12, 2001 is a foam cylinder with a vertical slit, using hook and loop straps to attach it to the animal and can be cut to size; and, Bowen, Hook and loop collar, U.S. Pat. No. 6,532,904, Mar. 18, 2003 is a rectangular apparatus with hooks on one side and loops on the other side for securing it to the animal and can, also, be cut to size. Labels are mentioned with very limited definition and function but are not claimed. The objections to both of these embodiments is the same as for Schmid et al. Albers, Animal collar for limiting head movement, U.S. patent application Ser. No. 11/545,361, Oct. 10, 2006, is a neck brace with a hook and loop fastening system to attach it to the animal. This collar is a molded device that totally restricts the movement of the animal's neck, would be very uncomfortable and couldn't be worn for long periods of time, although it would prevent the animal from reaching it's body with it's mouth. Markfield, Pet protective device, U.S. patent application Ser. No. 11/847,156, Aug. 29, 2007, is cone-shaped with opposing sheets of flexible, non-resilient material with a flexible, resilient material held between them. Hook and loop strips at intervals provide three size choices. This would be comparable to the hard collars in discomfort to the animal, although lighter weight. Davis, Animal medical collar, U.S. patent application Ser. No. 11/980,295, Oct. 30, 2007 has a fabric covered, annular disk construction with a drawstring for attaching it to the animal's head. This device is less bulky and restrictive than similar collars but still makes eating and lying down uncomfortable for the animal. Maroney and Bolger, Elizabethan pet collar, U.S. Patent D632,851 S is an ornamental design for an Elizabethan collar, which when assembled is cone-shaped and when fully disassembled at the connect point is u-shaped and lies flat. The collar is light weight and effectively would prevent the animal from bothering the treatment site or using its mouth to interfere with treatment. However, the construction of the collar would cause it to be comparable to the hard plastic collars, rigid and unyielding, although lighter weight.

### BRIEF DESCRIPTION OF THE INVENTION

This invention is a veterinary restraint collar for small animals, mostly cats and dogs, experiencing injury, surgery, dental or grooming procedures, for the purpose of preventing the animal from reaching the treatment site with its mouth or interfering with dental or grooming procedures.

With testing and use, it became obvious that improvements were needed to enhance the effectiveness of the '295 Collar.

A very practical improvement, selling the product as Veterinary Recovery Collar rather than Veterinary Restraint Collar, increased sales considerably. It emphasizes the positive aspect of the device and clearly defines its intended use. It, too, supports the designation of VRC, which has been used in advertisements and stationary.

The addition of the stays on the radius of the Collar was important as they made the Collar a more firm barrier against the animal's efforts, while still retaining its soft, flexible and non-resilient properties, as the Collar folds flat for storage, a feature that is very desirable for efficient use of storage space.

The sewing of binding around the neck opening and the perimeter of the Collar added the same features as the stays in addition to being the improved drawstring passage for the one layer collars through the use of wider binding.

The need to offer a full range of sizes was both practical, as the competing hard plastic devices are offered in many sizes, and essential, as the soft Collar is not comfortable and tolerable to the animal if it does not fit properly. There are sizes to fit animals from birds, puppies and kittens to very large dogs, and all are effective. Requests were made for a size for parrots who sometimes have a tendency to pluck their feathers. This was created, although they're not being used extensively To encourage the use of the correct size for each animal, size labels are adhered to the Collar with the size given in inches and centimeters, since there was some tendency for the user to take the one-size-fits-all approach. The Collar must extend beyond the animal's mouth to be effective.

With the creation of multiple sizes of the Collar, it became a challenge to test a range of materials to find the best soft, flexible and non-resilient material for each size, particularly the larger sizes. The larger the Collar, the larger and stronger the animal. The soft recovery Collar has overwhelmingly been accepted for dogs and cats, as they allow the animal to effectively recover comfortably. But the larger sizes are especially appreciated, as they are the most unwieldy and heavy in the hard plastic devices.

At the request of the companies, private labels containing each company's name were, also, adhered to the Collar, so that their customers would identify the product with their company and continue to buy it from them.

The construction of the neck opening of the one layer collars was changed to accommodate the additional bulk of material in the large Collars. The width of the binding into which the tie is inserted is considerably larger, making the Collar less bulky against the animal's neck and more comfortable.

Animals experiencing injury, surgery or dental procedures require post-treatment care to aid their recovery. Instructions from veterinary professionals begin with post-treatment instructions to staff and continue to owners when the animal is released to go home. The post-treatment instructions panel is smooth and available for writing such instructions and the identification of the animal, using permanent ink. This places these directives all in the same place, visible when the Collar is on the animal and assures that they are for that animal. Additionally, the owners sometimes lose instructions given to them, and this would eliminate that problem. They also have a tendency to remove devices from their pets when they take them home and are less likely to do so if they are looking at an instruction that tells them when they can safely remove the device.

### BRIEF DESCRIPTION OF THE DRAWINGS

FIG. 1 is a front view of a cat that has the veterinary restraint collar 1 of this invention, on its neck.

FIG. 2 is a front view of a post-treatment instructions panel 7, composed of a smooth material 23, of the collar 1 of FIG. 1 that is constructed of two or more layers of material 24.

FIG. 3 is a front view of a post-treatment instructions panel 11, composed of a smooth material 23, of the collar 1 of FIG. 1 that is constructed of one layer of material 24.

FIG. 4 is a side elevation view of the collar 1 of FIG. 1, lying flat, constructed of two or more layers of material 24 and having a post-treatment instructions panel 7, composed of a smooth material 23, sewn 22 into it.

FIG. 5 is a side elevation view of the collar 1 of FIG. 1, lying flat, constructed of one layer of material 24 and having a post-treatment instructions panel 11, composed of a smooth material 23, sewn 22 into it.

FIG. 6 is a cross-sectional view of the construction of a stay 13, of the collar 1 of FIG. 1, that is not adjacent to a post-treatment instructions panel 7, 11.

FIG. 7 is a cross sectional view of the construction of a stay 12, of the collar 1 of FIG. 1, that is adjacent to a post-treatment instructions panel 7, 11.

FIG. 8 is a side view of the binding material 20 and stitching 22 that attaches the binding to the collar 1 of FIG. 1 to form a stay 12, 13, the perimeter binding 5 and the neck opening 10, 14 of the collar 1 of FIG. 1.

### DETAILED DESCRIPTION OF THE DRAWINGS

As shown in FIG. 1, the veterinary restraint collar 1 of this invention is around the neck of a cat to restrict access of the cat's mouth 3 and head 2 to the remainder of its body 4 after injury, surgery, dental or grooming treatment. The collar 1 is constructed of a soft, flexible material 24 and reinforced with stays 13 and perimeter binding 5. The stay 13 and perimeter binding 5 are created by sewing 22 binding 20 around folds of material 24. The resultant area between the stays 13 is a panel 6 of the collar 1.

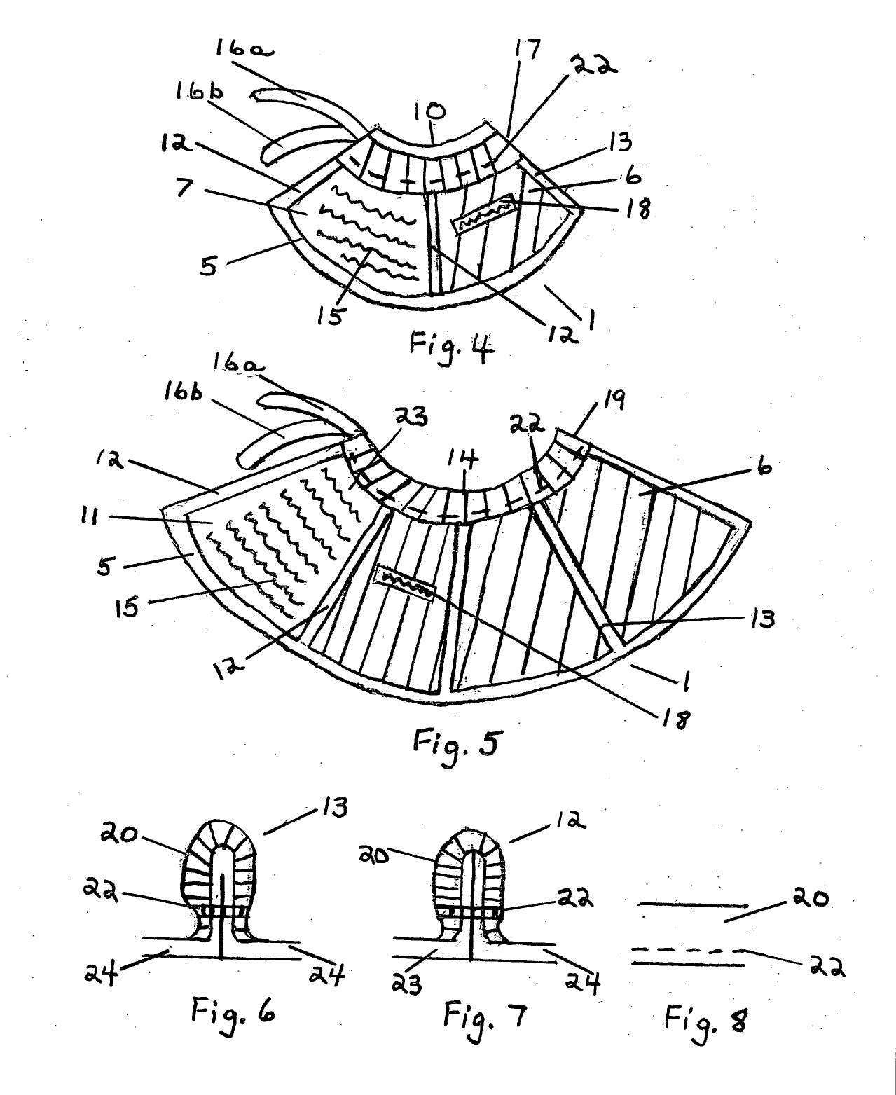

FIG. 2 shows a post-treatment instructions panel 7 for insertion in a collar 1 made of two or more layers of material 24. The material 23 for the panel 7 is smooth and capable of being written on with permanent ink 15. The stays 12 are shown and described with FIG. 7. The perimeter 5 is formed by placing all outer edges of the layers of the collar 1 together, with the post-treatment instructions panel 7 being a panel 7 of the top layer, and sewing 22 binding 20 around them, The neck opening 10 is constructed by placing binding 20 around the opening 10, positioning an additional circle of material 24 under the binding 20 and sewing 22 the binding 20 and the top edge of the circle of material 24 to the neck opening 10 of the collar 1. The top edge of the post-treatment instructions panel 7 is then inserted under the bottom edge of the circle of material 24, and the bottom edge of the circle of material 24 is then sewn 22 to the collar 1, creating a passage 17 for receiving an elasticized drawstring 16a, 16b to secure the collar 1 to the animal's head.

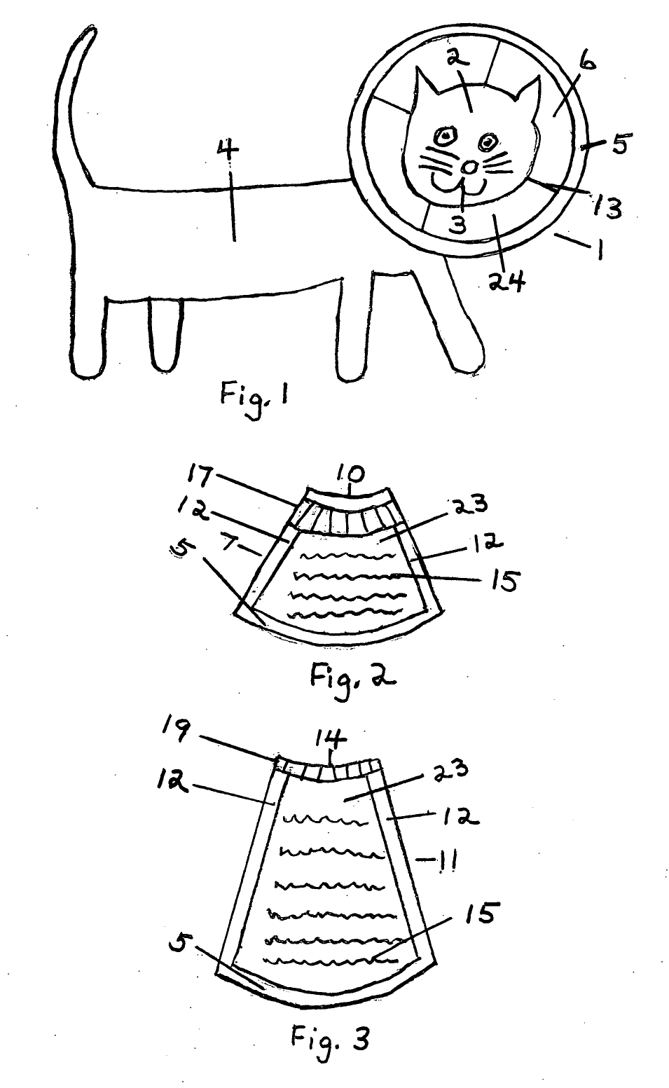

FIG. 3 shows a post-treatment instructions panel 11 for insertion in a collar 1 made of one layer of material 24. The material 23 for the panel 11 is smooth and capable of being written on with permanent ink 15. The stays 12 are shown and described with FIG. 7. The perimeter 5 is formed by sewing 22 binding 20 around the outer edge of the material 23. The neck opening 14 is constructed by sewing 22 binding 20, wide enough to be the receptacle 19 of elasticized drawstring 16a,16b, around the inner neck opening 14 of material 23 to secure the collar 1 to the animal's neck.

FIG. 4 illustrates a collar 1 that has two or more layers of material 24, the post-treatment instructions panel 7, which is visible when the collar is around the neck of an animal and composed of a smooth material 23 that can be written on with permanent ink 15, being a panel 7 of the top layer, that are sewn 22 together around their outer edges with a binding 20 creating the perimeter binding 5 of the collar 1. Binding 20 is placed around the neck opening 10, a circle of material 24 is inserted under the binding 20 which, when sewn 22 together results in the top of the passage 17 for accepting an elasticized drawstring 16a, 16b. To complete the passage 17, the top edge of the post-treatment instructions panel 11 is inserted under the bottom edge of the circle of material 24 and both are stitched 22 to the collar 1. The stays 12 are shown and described with FIG. 7, and the stays 13 are shown and described with FIG. 6. A size label 18 is adhered to one panel 6 of the collar 1, other than the post-treatment instructions panel 7.

FIG. 5 illustrates a collar 1 that has one layer of material 24, the post-treatment instructions panel 11, which is visible when the collar is around the neck of an animal and is one panel 11 of that layer that is comprised of a smooth material 23, capable of being written on with permanent ink 15, which has a binding 20 sewn 22 around its outer edge creating the perimeter binding 5 of the collar 1. Binding 20 wide enough to be the receptacle 19 for the elasticized drawstring 16a, 16b is sewn 22 around the neck opening 14, which results in the passage 19 for accepting an elasticized drawstring 16a, 16b. The stays 12 are shown and described with FIG. 7, and the stays 13 are shown and described with FIG. 6. A size label 18 is adhered to one panel 6 of the collar 1, other than the post-treatment instructions panel 11.

As shown in FIG. 6, the construction of a stay 13 that isn't adjacent to a post-treatment instructions panel 7, 11 is achieved by stitching 22 a binding 20 around a fold of material 24.

FIG. 7 details the construction of a stay 12 that is adjacent to a post-treatment instructions panel 7, 11. The edge of the post-treatment instructions panel material 23 must be aligned with the edge of the material 24; the binding must be wrapped around them; and, the binding must be stitched 22 through both materials 23, 24.

FIG. 8 is a front view of a piece of binding 20 that has stitching 22 applied to it. Binding 20 is used to construct the neck openings 10, 14, stays 12, 13 and outward perimeter 5 of the collar 1.

What is claimed is:

1. In a veterinary restraint collar for use around the neck of an animal such as a cat or dog to restrict access of the animal's head and mouth to the remainder of its body, and having one or more layers of generally concentric rings of soft, flexible material with inner and outer margins, the inner margin defining a neck hole with a drawstring retaining passage to insert an elasticized drawstring for securing the collar on the animal, and the rings having sufficient radial width to extend the outer margin beyond the animal's mouth, the improvement comprising:
A post-treatment instructions panel on one of the rings positioned to be visible when the collar is around the neck of an animal, and composed of smooth material capable of receiving instructions written by veterinary professionals, regarding the animal's care, to assure the ready availability of the instructions for the well-being of the animal.

2. The improvement defined in claim 1 wherein the post-treatment instructions area comprises a layer of smooth material that is one panel of the collar.

3. The improvement defined in claim 1 wherein the rings have radial reinforcing stays spaced apart on the rings, bindings around the inner and outer margins and the post-treatment instructions panel sewn into the two stays and the bindings on the inner and outer margins.

4. In a veterinary restraint collar for use around the neck of an animal such as a cat or dog to restrict access of the animal's head and mouth to the remainder of its body, the combination of:
At least one ring of flexible and non-resilient material defining a neck hole and having a radial width sufficient to block access of the animal's mouth to the remainder of its body when the collar is around its neck; and,
A post-treatment instructions panel on one side of the ring, positioned to be visible when the collar is on the animal, composed of smooth material capable of being written on with permanent ink, thereby to receive and display instructions from veterinary professionals to assure the welfare of the animal.

5. A veterinary restraint collar as defined in claim 4 wherein the post-treatment instructions panel comprises a layer of smooth material sewn into the radial reinforcing stays and the bindings on the inner and outer margins.
